(19) United States
(12) Patent Application Publication
(10) Pub. No.: US 2015/0180671 A1
(43) Pub. Date: Jun. 25, 2015

(54) AUTHENTICATION SYSTEM, METHOD FOR AUTHENTICATION, AUTHENTICATION DEVICE AND DEVICE TO BE AUTHENTICATED

(71) Applicant: Fujitsu Semiconductor Limited, Yokohama-shi (JP)

(72) Inventor: SUSUMU YAMASHITA, Akiruno (JP)

(73) Assignee: FUJITSU SEMICONDUCTOR LIMITED, Kanagawa (JP)

(21) Appl. No.: 14/555,839

(22) Filed: Nov. 28, 2014

(30) Foreign Application Priority Data
Dec. 24, 2013 (JP) 2013-265237

(51) Int. Cl. H04L 9/32

(52) U.S. Cl. CPC H04L 9/3271

(57) ABSTRACT

An authentication system includes a device to be authenticated and an authentication device. The device to be authenticated includes a first communication unit configured to transmit an instruction code and a first comparison value, and to receive a random number, a first memory unit, and a first control unit configured to create the first comparison value based on the random number, the common secret identification information and the instruction code. The authentication device includes a second communication unit configured to transmit the random number and to receive the instruction code and the first comparison value, a second memory unit, and a second control unit configured to generate the random number, create a second comparison value, compare the first comparison value with the second comparison value, and execute the instruction code when the first comparison value matches with the second comparison value.

### CROSS-REFERENCE TO RELATED APPLICATION

This application is based upon and claims the benefit of priority of the prior Japanese Patent Application No. 2013-265237, filed on Dec. 24, 2013, the entire contents of which are incorporated herein by reference.

### FIELD

The embodiments discussed herein are related to authentication system, a method for authentication, an authentication device and a device to be authenticated.

### BACKGROUND

In a recent year, in an embedded apparatus, a cheap imitation product, which has a function equal to a regular product, is produced and appears in the market. Because the imitation product has the function that is equal to the regular product and is cheap, a case, which is purchased in substitution for the regular product, increases. Therefore, the unit sales of the regular product decrease, and a great loss occurs.

For example, there is the embedded apparatus that cooperates with a plurality of products through communication. With such an embedded apparatus, the control of a different product is enabled according to an operation of a certain product. For example, the plurality of cooperating products is a car navigation product and an air-conditioner. In this case the air-conditioner is controllable according to an operation of the car navigation product.

Among a plurality of embedded apparatuses which cooperate with, the imitation product is used for some products, and the regular product may be controlled by the imitation product. In such a case, it is demanded to authenticate whether a connected apparatus is a regular product, or an imitation product (for example, following patent document 1-3). As a method to distinguish whether or not the connected apparatus is a regular product, an authentication method by a challenge and response method is used.

According to the challenge and response method, an apparatus to authenticate (below, called as an authentication device) and a device to be authenticated share with secret identification information (ID (Identification Data), below called as ID) beforehand. When the device to be authenticated outputs an authentication request for the authentication device, the authentication device generates a random number (challenge value), and transmits it to the device to be authenticated. Then the device to be authenticated calculates an MAC (Message Authentication Code) value based on the random number (challenge value) and the secret ID, and transmits the MAC value as a response value to the authentication device. In addition, the authentication device calculates the MAC value based on the random number and the secret ID as same manner. And the authentication device, when the response value (the MAC value) which is received from the device to be authenticated matches with the MAC value which is calculated, determines that the device to be authenticated is a regular product, and accepts the control of the device to be authenticated.

However, there is a possibility of masquerade to the regular product by the imitation product, when there are multiple products for the authentication. In this case, when the authentication device generates a random number (challenge value), and transmits it to the device to be authenticated, an imitation device to be authenticated transmits the received random number (challenge value) to the regular device to be authenticated. The regular device to be authenticated calculates the response value and transmits the response value to the imitation device to be authenticated. Then the imitation device to be authenticated transmits the received response value to the authentication device. Because the response value is the MAC value which is created by the regular product, the response value matches with the MAC value which is calculated by the authentication device. Therefore, the authentication device determines that the imitation device to be authenticated is the regular product.

Therefore, the encryption of the instruction code is made in addition to the challenge and response method. In this method, the authentication device and the device to be authenticated further share a common key in addition to the secret ID. After having succeeded in the authentication processing by the challenge and response method, the device to be authenticated encrypts the instruction code for controlling the authentication device according to the common key, and transmits it the authentication device. And the authentication device, when receiving the encrypted instruction code, decrypts it according to the common key, and acquires the original instruction code. And the authentication device carries out the processing corresponding to the instruction code.

In this way, in addition to the authentication by the challenge and response method, the instruction code is encrypted by the common key. The device to be authenticated which does not have the common key is unable to encrypt the instruction code. Therefore, the device to be authenticated of the imitation is unable to become masquerade with the regular product and to control with the regular product.

### PATENT DOCUMENT

[Patent document 1] Japanese Laid-open Patent publication No. 2002-063139
[Patent document 2] Japanese Laid-open Patent publication No. 2011-176649
[Patent document 3] Japanese Laid-open Patent publication No. 2012-174195

### SUMMARY

According to a first aspect of the embodiment, an authentication system includes a device to be authenticated including, a first communication unit configured to transmit an instruction code for control of an authentication device and a first comparison value to the authentication device, and to receive a random number from the authentication device, a first memory unit which stores common secret identification information, and a first control unit configured to create the first comparison value based on the random number, the common secret identification information and the instruction code in response to a reception of the random number, and the authentication device including, a second communication unit configured to transmit the random number to the device to be authenticated and to receive the instruction code and the first comparison value from the device to be authenticated, a second memory unit which stores the common secret identification information; and a second control unit configured to generate the random number in response to a reception of the instruction code, create a second comparison value based on the random number, the common secret identification information and the instruction code, compare the first comparison value which is received from the device to be authenticated with the second comparison value, and execute the instruction code when the first comparison value matches with the second comparison value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining the challenge and response method according to an embodiment.

FIG. 2 is a diagram explaining another embodiment of the challenge and response method.

FIG. 3 is a diagram explaining a masquerade by the device to be authenticated 30 of the imitation.

FIG. 4 is a diagram explaining an embodiment when the encryption of the instruction code EX is performed in addition to the challenge and response method.

FIG. 5 is a diagram explaining hardware constitution of the authentication device 10 according to the embodiment.

FIG. 6 is a diagram explaining constitution of the device to be authenticated 20 according to the embodiment.

FIG. 7 is a diagram explaining a flow of the process of the authentication processing system according to the embodiment.

FIG. 8 is a diagram explaining the prevention of the spoofing attack by the authentication system according to the embodiment.

FIG. 9 is a flow diagram explaining a first embodiment of a flow of the processing when the MAC calculation unit 107, 205 illustrated in FIG. 5 and FIG. 6 are realized by software.

FIG. 10 is a flow diagram explaining a second embodiment of a flow of the processing when the MAC calculation unit 107, 205 illustrated in FIG. 5 and FIG. 6 are realized by software.

FIG. 11 is a diagram explaining a construction when the MAC calculation units 107, 205 are realized by hardware, according to a third embodiment.

FIG. 12 is a diagram explaining a construction when the MAC calculation units 107, 205 are realized by hardware, according to a fourth embodiment.

FIG. 13A and FIG. 13B are diagrams explaining a specific example of the process of the authentication device 10 in the authentication system according to the embodiment.

FIG. 14 is a diagram explaining a specific example of the instruction code transmission process of the device to be authenticated 20 in the authentication system in FIG. 13.

FIG. 15 is a diagram explaining a specific example of the MAC value calculation and transmission process of the device to be authenticated 20 in the authentication system in FIG. 13A and FIG. 13B.

### DESCRIPTION OF EMBODIMENTS

When the instruction code is encrypted in addition to the challenge and response method, it is necessary to add the encryption and decryption process of the instruction code in addition to increasing of the encryption and decryption for sharing the common key. Therefore, cost increases by increasing the encryption processing, and the load to execute the authentication processing becomes higher.

In addition, the authentication processing is periodically carried out because the regular product may be replaced with an imitation product after the authentication processing. However, the communication data between the authentication device and the device to be authenticated increase because executing the authentication process in the timing when operation does not occur.

Firstly an authentication by the challenge and response method will be explained.

(Challenge and Response Method)

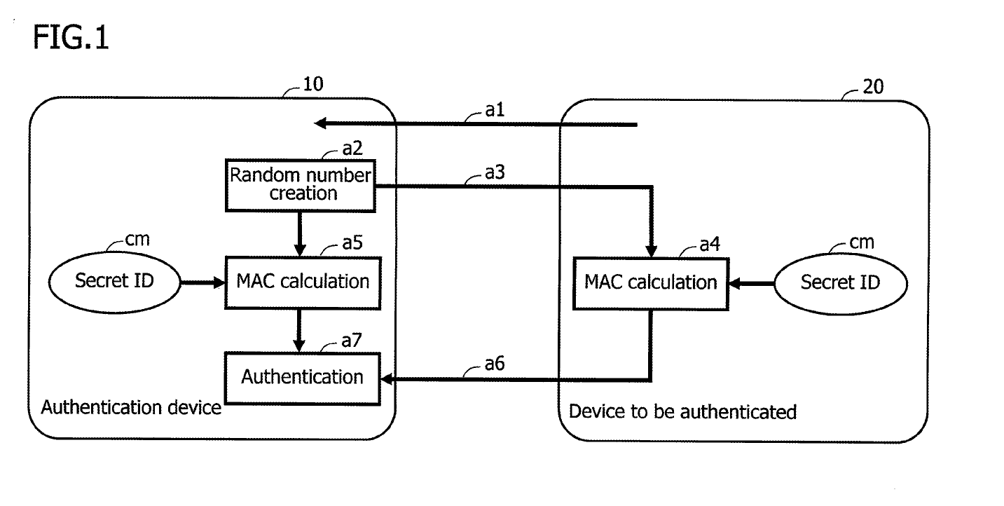

FIG. 1 is a diagram explaining the challenge and response method according to an embodiment. The authentication system depicted by FIG. 1 has an authentication device 10 and a device to be authenticated 20. The authentication device 10 and the device to be authenticated 20 communicate with each other through a wireless or a cabled communication line.

For example, the authentication device 10 corresponds to an air-conditioner, and the device to be authenticated 20 corresponds to a car navigation device. The car navigation device and the air-conditioner cooperates with each other, the air-conditioner is controlled according to an operation of the car navigation device. But, the authentication device 10 and the device to be authenticated 20 are not limited to the embodiment and may be a different device to connect through vehicle installation networks.

According to the challenge and response method, the authentication device 10 and the device to be authenticated 20 share the secret ID cm beforehand. Firstly the device to be authenticated 20 outputs an authentication request to the authentication device 10 according to the embodiment as depicted by FIG. 1 (a1). The authentication device 10 receives the authentication request, and generates random number (challenge value) R1 (a2). Then, the authentication device 10 sends the random number (challenge value) R1 which is generated to the device to be authenticated 20 (a3). The device to be authenticated 20 generates MAC (Message Authentication Code) value M1 based on the random number (the challenge value) R1 and the secret ID cm when the device to be authenticated 20 receives the random number (challenge value) R1 from the authentication device 10 (a4). The MAC value M1 is defined as information to authenticate a message. For example, the device to be authenticated 20 calculates the MAC value M1 based on HMAC (Hash-based message Authentication code) method or AES (Advanced Encryption Standard) method as input by the common key (in the embodiment, the secret ID cm) and message of a predetermined length to be authenticated (in the embodiment, the random number R1).

Then, the device to be authenticated 20 transmits the MAC value M1 which is calculated to the authentication device 10 as a response value (a6). In addition, the authentication device 10 calculates the MAC value M2 based on the random number R1 and the secret ID cm which is generated as same as the device to be authenticated 20 (a5). And the authentication device 10, when receiving the response value (the MAC value M1) from the device to be authenticated 20, inspects whether or not both MAC value matches with each other by comparing the MAC value M1 with the MAC value M2 which is calculated (a7). When both MAC values matches with each other, the authentication device 10 determines that the device to be authenticated 20 is a regular product, and carries out processing based on an instruction code EX (not illustrated in FIG. 1) which controls the authentication device 10 and is received from the device to be authenticated 20. On the other hand, when the both MAC values do not match with each other, the authentication device 10 determines that the device to be authenticated 20 is an imitation product, and does not perform control according to the device to be authenticated 20.

The device to be authenticated 20 of the imitation does not have the secret ID cm. The device to be authenticated 20 of the imitation which does not have the secret ID cm is unable to generate the response value M1 that is the same as the MAC value M2 of which the authentication device 10 generates. Therefore, the device to be authenticated 20 of the imitation is not determined as the regular product and is prohibited to perform the control of the authentication device 10.

In addition, the device to be authenticated 20 may be replaced with an imitation from the regular product after having succeeded in the authentication. Therefore, for example, the authentication device 10 periodically performs the authentication processing of the device to be authenticated 20. For example, the device to be authenticated 20 has a timer function and periodically outputs the authentication request to the authentication device 10.

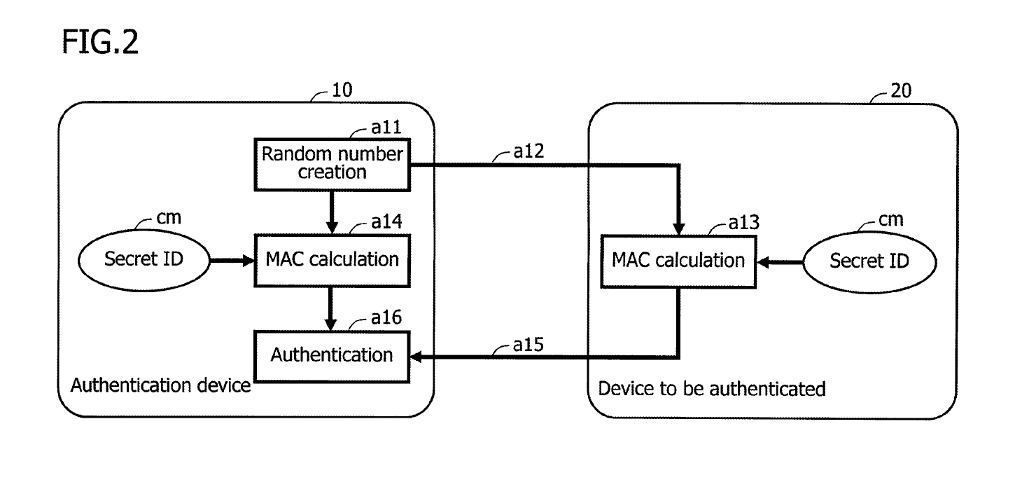

FIG. 2 is a diagram explaining another embodiment of the challenge and response method. The authentication device 10 depicted by FIG. 2 generates the random number (the challenge value) R1 in periodical timing or any timing (a11) and outputs it to the device to be authenticated 20 (a12). By this process, the authentication processing in the device to be authenticated 20 is periodically carried out. That is, the device to be authenticated 20 generates the MAC value M1 based on the random number (the challenge value) R1 and the secret ID cm when receiving the random number (the challenge value) R1, as same as the embodiment depicted by FIG. 1 (a12). The following processing (a13-a16) is similar to the embodiment in FIG. 1.

The device to be authenticated 20 is confirmed to be a regular product continuously by performing the authentication process in periodical timing or any timing. But the communication data quantity between the authentication device 10 and the device to be authenticated 20 increases by performing the authentication process in periodical or any timing. In addition, quantity of communication data increases more, when there are many numbers of target devices to be authenticated 20 of which the authentication device 10 authenticates.

In addition, a masquerade by the device to be authenticated 30 of the imitation using the device to be authenticated 20 of the regular product is enabled when a plurality of devices to be authenticated 20 connects with the authentication device 10. The masquerade method to the regular product by the device to be authenticated 30 of the imitation will be explained successively.

(Masquerade by Imitation)

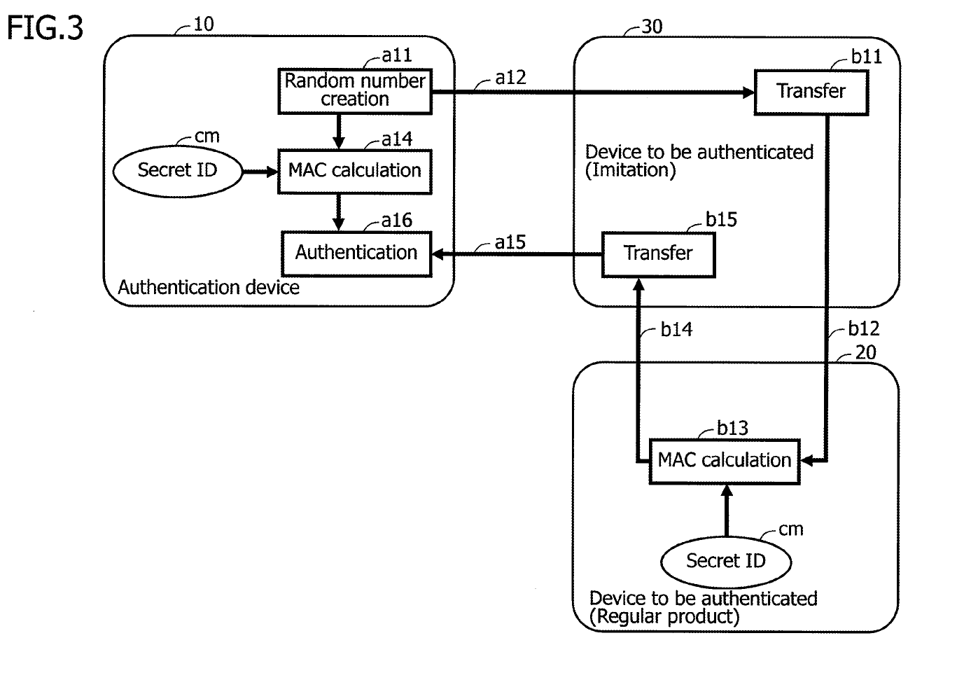

FIG. 3 is a diagram explaining a masquerade by the device to be authenticated 30 of the imitation. System depicted by FIG. 3 has the authentication device 10 and the device to be authenticated 30 of the imitation and the device to be authenticated 20 of the regular product. Each device 10, 20 and 30 communicate each other.

As explained by FIG. 1 and FIG. 2, the device to be authenticated 20 of the regular product has a function to generate the response value in response to the reception of the random number (the challenge value) R1 and to send the response value M1 which is generated to the device of the origin of transmission of the random number (the challenge value) R1. Therefore, the device to be authenticated 30 of the imitation, when receiving the random number (the challenge value) R1 from the authentication device 10 (a12), transfers the random number (the challenge value) R1 which is received to the device to be authenticated 20 of the regular product (b11, b12). The device to be authenticated 20 of the regular product, when receiving the random number (the challenge number) R1, generates the response value (b13) and sends it to the device to be authenticated 30 of the imitation which is an origin of transmission of the random number (challenge value) (b14). Then, the device to be authenticated 30 of the imitation, when receiving the response value M1 from the device to be authenticated 20 of the regular product, transfers the response value M1 to the authentication device 10 (b15, a15).

The response value M1, that the authentication device 10 receives from device to be authenticated 30 of the imitation, is the response value that the device to be authenticated 20 of the regular product generated. Therefore, the response value M1, that the authentication device 10 receives from the device to be authenticated 30 of the imitation, matches with the MAC value M2 of which the authentication device 10 generates. Therefore, the authentication device 10 determines that the device to be authenticated 30 of the imitation is the device to be authenticated 20 of the regular product, and accepts control from the device to be authenticated 30 of the imitation. In other words, the device to be authenticated 30 of the imitation masquerade to a regular product and is able to control the authentication device 10.

Therefore, the encryption of the instruction code EX is made in addition to the challenge and response method to prevent a masquerade by the device to be authenticated 30 of the imitation.

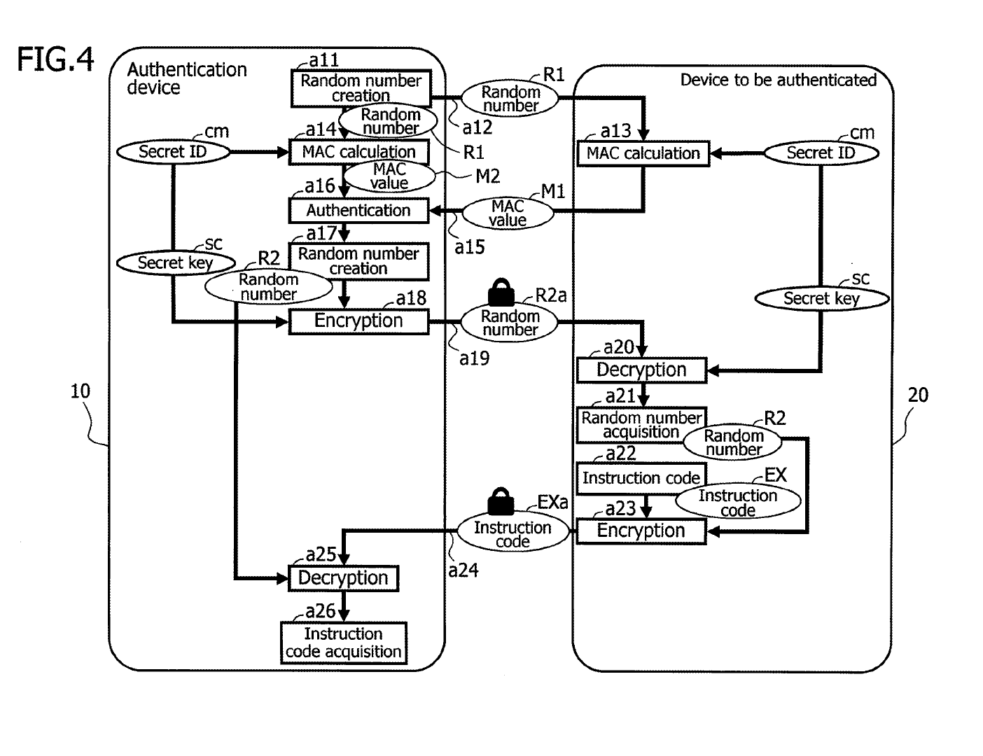

FIG. 4 is a diagram explaining an embodiment when the encryption of the instruction code EX is performed in addition to the challenge and response method. In authentication process in FIG. 4, the device to be authenticated 20 encrypts the instruction code EX based on a common key after the authentication of the challenge and response method. In FIG. 4, the authentication device 10 and the device to be authenticated 20 share a private key sc beforehand in addition to the secret ID cm.

Specially, as similar to FIG. 1 and FIG. 2, the authentication device 10 generates the random number (the challenge value) R1, sends it to the device to be authenticated 20, receives the response value M1 from the device to be authenticated 20 and inspects whether the response value M1 and the MAC value M2 which is generated match with each other (a11˜a16). Then the authentication device 10 generates random number R2 which becomes the common key (a17). Next, the authentication device 10 encrypts the random number R2 using the private key sc sharing with the device to be authenticated 20 (a18), and transmits it to the device to be authenticated 10 (a19). The device to be authenticated 20, when receiving the encrypted random number R2a, decrypts it based on the private key sc which shares (a20), and acquires the random number R2 (a21). The random number R2 which is acquired is the common key with the authentication device 10 and the device to be authenticated 20.

Then, the device to be authenticated 20 generates an instruction code EX which instructs a control for the authentication device 10 (a22), encrypts the instruction code EX by a common key (random number R2) (a23), and transmits the encrypted instruction code to the authentication device 10 (a24). And the authentication device 10 decrypts the encrypted instruction code EXa based on a common key (the random number R2) which is shared (a25), and acquires the instruction code EX (a26). The authentication device 10, when acquiring the instruction code EX, carries out processing based on the instruction code EX.

According to the authentication process in FIG. 4, the device to be authenticated 30 of the imitation, even if receiving the encrypted random number R2 from the authentication device 10, is unable to decrypt it because the device to be authenticated 30 of the imitation has not the private key. Accordingly, the device to be authenticated 30 of the imitation is unable to acquire the common key (the random number R2). Because the device to be authenticated 30 of the imitation, which does not have the common key, is unable to encrypt the instruction code EX of which own publishes, the device to be authenticated 30 fails in the authentication.

In addition, as exemplified in FIG. 3, for example, when the device to be authenticated 30 of the imitation transfers the encrypted random number R2 to the device to be authenticated 20 of the regular product, the device to be authenticated 20 of the regular product replies the information that the instruction code EX, of which the device to be authenticated 20 of the regular product publishes, is encrypted, to the device to be authenticated 30 of the imitation. Therefore, the device to be authenticated 30 of the imitation is unable to receive the information that the instruction code EX, of which the device to be authenticated 30 of the imitation publishes, is encrypted, from the device to be authenticated 20 of the regular product. Therefore, it is not possible that the device to be authenticated 30 of the imitation sends the information that the instruction code EX of which the own device publishes, to the authentication device 10, thereby the device to be authenticated 30 of the imitation is unable to be masquerade to the regular product even when using the device to be authenticated 20 of the regular product.

However, according to the authentication method depicted by FIG. 4, the encryption and decryption process by the secret key and the encryption and decryption process of the instruction code EX by the common key (the random number R2) are necessary in comparative to the method depicted by FIG. 1 and FIG. 2. Therefore, the encryption and decryption processes increase, and the processing becomes complicated. Thereby, the load of the processing increases, and the cost increases, too.

Therefore, according to the authentication method according to the embodiment, the device to be authenticated 20 transmits the instruction code EX which controls the authentication device 10 to the authentication device 10, and the authentication device 10 generates the random number (challenge value) R1 in response to the reception of the instruction code EX and sends it to the device to be authenticated 20. In addition, the device to be authenticated 20 generates a first comparison value (the MAC value/the response value) M1 based on the random number R1, the secret ID cm, of which the authentication device 10 and the device to be authenticated 20 have commonly, and the instruction code EX, and sends it to the authentication device 10 in response to the reception of the random number R1. In addition, the authentication device 10 generates second comparison value (the MAC value) M2 based on the random number R1 and the secret ID cm and the instruction code EX in response to the reception of the instruction code EX. And the authentication device 10 carries out the instruction code EX when the first comparison value M1, which is received from the device to be authenticated 20, matches with the second comparison value M2.

The authentication system according to the embodiment generates the MAC value M2 based on the instruction code EX in addition to the random number R1 and the secret ID cm. It is possible that the device to be authenticated 20 of the regular product generates the MAC value M2 as same as the MAC value M1 that the authentication device 10 generates, based on the instruction code EX and the secret ID cm, because the device to be authenticated 20 has the secret ID cm. On the other hand, it is not possible that the device to be authenticated 30 of the imitation generates the MAC value M2 as same as the MAC value M1 that the authentication device 10 generates, because the device to be authenticated 30 of the imitation does not have the secret ID cm although having the instruction code EX. Therefore, the device to be authenticated 30 of the imitation fails in the authentication.

Next, constitution of the authentication device 10 and the device to be authenticated 20 in the authentication system according to the embodiment will be explained. Firstly, the constitution of authentication device 10 will be explained.

(Constitution Example of the Authentication Device)

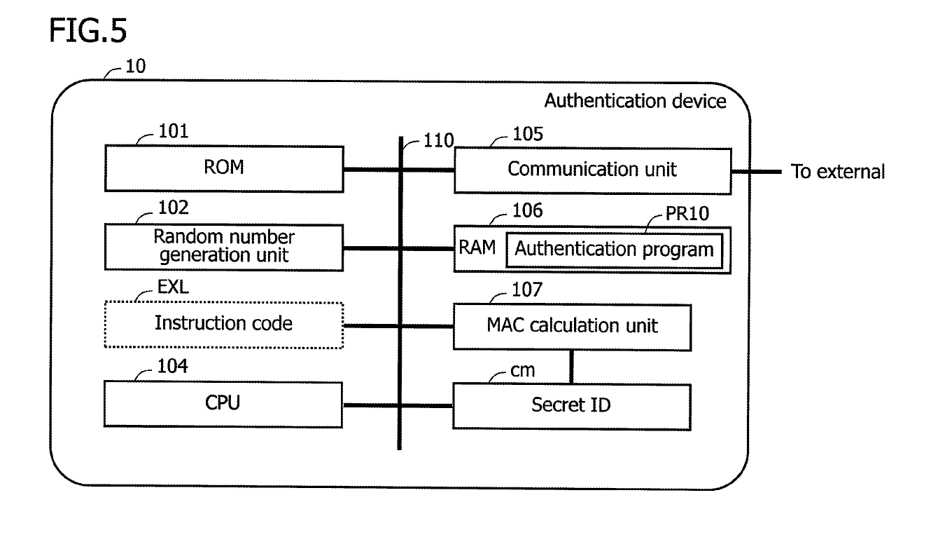

FIG. 5 is a diagram explaining hardware constitution of the authentication device 10 according to the embodiment. The authentication device 10 has a ROM (Read Only Memory) 101 which stores the secret ID cm, a random number generation unit 102, a CPU (Central Processing Unit) 104, a communication unit 105, a RAM (Random Access Memory) 106, and a MAC calculation unit 107, for example. The all components are connected through a bus 110 each other.

The random number generation unit 102 generates the random number R1 (referring to FIG. 4). The random number generation unit 102 may be realized by hardware or by software. In addition, the communication unit 105 controls the transmission and reception of the data with an outside device including the device to be authenticated 20 through wireless or cabled communication. In addition, the secret ID cm is information shared with the device to be authenticated 20 beforehand. The secret ID cm may be stored in the ROM 101, and may be equipped as fixed information by hardware. In addition, the secret ID cm may be a plurality of IDs.

The MAC calculation unit 107 calculates the MAC value M2 based on MAC function of which the secret ID cm and the random number and the instruction code are input. The MAC calculation unit 107, as similar to the random number generation unit 102, may be realized by hardware, or may be realized by software. In addition, the MAC calculation unit 107 may be constructed to acquire the secret ID cm without an intervening of the CPU 104. Or, the MAC calculation unit 107 retrieves the secret ID cm when the MAC calculation unit 107 is constructed by software.

In addition, when the authentication processing in the embodiment is carried out by software, the RAM 106 stores authentication program PR10 of the authentication device 10 side, for example. The CPU 104 collaborates with the authentication program PR10 and performs the authentication process of authentication device 10 side in the embodiment.

In addition, the authentication device 10 according to the embodiment may have list EXL of the instruction codes EX of the device to be authenticated 20 more. For example, the CPU 104 of the authentication device 10 performs process corresponding to the instruction code EX with reference to the list EXL of the instruction codes which is held, based on the instruction code EX which is received from the device to be authenticated 20. However, it is not required that the authentication device 10 has the list EXL of the instruction codes.

(Constitution Example of the Device to be Authenticated)

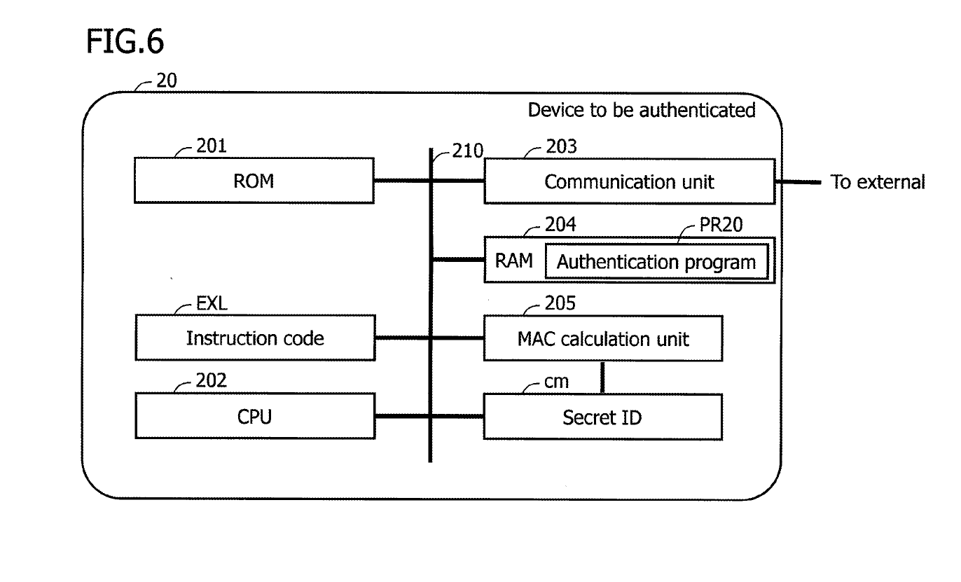

FIG. 6 is a diagram explaining constitution of the device to be authenticated 20 according to the embodiment. The device to be authenticated 20 has a ROM (Read Only Memory) 201, a list EXL of the instruction codes EX, a CPU (Central Processing Unit) 202, a communication unit 203, a RAM (Random Access Memory) 204, a MAC calculation unit 205. The all components are connected through a bus 210 each other. Device to be authenticated 20 shares the secret ID cm with the authentication device 10 as illustrated by FIG. 5. In addition, the communications unit 105 and the MAC calculation unit 107 are similar to that in FIG. 5.

In addition, the RAM 204 memorizes the authentication program PR20 of the device to be authenticated 20 side, when the authentication processing in the embodiment mode is carried out by software. The CPU 104 collaborates with the authentication program PR20 and performs authentication process of the device to be authenticated 20 side in the embodiment. In addition, the device to be authenticated 20 has the list EXL of the instruction code EX which controls the authentication device 10.

Then, the process of authentication processing system according to the embodiment will be explained.

(Processing According to the Embodiment)

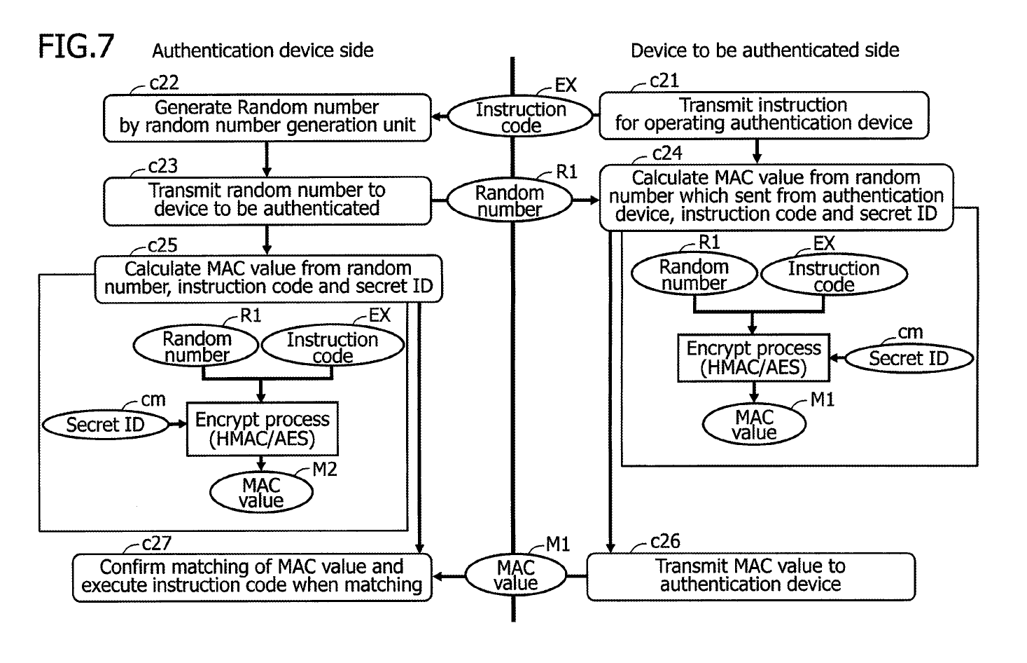

FIG. 7 is a diagram explaining a flow of the process of the authentication processing system according to the embodiment. At first, the device to be authenticated 20 transmits the instruction code EX to the authentication device 10 at the timing when the device to be authenticated 20 controls the authentication device 10 (c21). The random number generation unit 102 in the authentication device 10 generates the random number R1 in response to the reception of the instruction code EX (c22). And the authentication device 10 transmits the generated random number R1 to the authentication device 10 (c23).

The device to be authenticated 20 generates the MAC value M1 when the device to be authenticated 20 receives the random number R1 from the authentication device 10 (c24). Specially, the MAC calculation unit 205 in the device to be authenticated 20 is inputted the received random number R1, the value based on the instruction code EX and the secret ID cm, and calculates and generates the MAC value M1. And the device to be authenticated 20 transmits the MAC value M1 which is generated to the authentication device 10 (c26).

In addition, the authentication device 10 calculates and generates the MAC value M2 from inputs of the random number R1, the value based on the instruction code EX and the secret ID cm after having transmitted the random number R1 to the device to be authenticated 20 (c25). And the authentication device 10, when receiving the MAC value M1 from the device to be authenticated 20, compares the generated MAC value M2 with the received MAC value M1 and determines that the device to be authenticated 20 is a regular product when both MAC values match with each other. The authentication device 10 carries out processing corresponding to the instruction code EX which is transmitted from the device to be authenticated 20 when it is determined that the device to be authenticated 20 is a regular product (c27).

In addition, in the embodiment, the timings when the device to be authenticated 20 calculates the MAC value M1 and the authentication device 10 calculates the MAC value M2, are not limited to the example of FIG. 7. Each MAC value M1, M2 may be generated before the comparison process of MAC value.

In addition, a case to use single secret ID cm is exemplified in the example of FIG. 7, but it is not limited to this example. That is, the secret ID cm used for the generation of the MAC value may be multiple pieces. In this case, for example, the authentication device 10 and the device to be authenticated 20 share plural secret IDs cm beforehand. It is possible that the authentication system make the generation of the MAC value by the third party more difficult by using plural secret IDs cm.

In addition, the processing (c21-c27) may be omitted when the authentication device 10 is already carrying out same instruction code EX. Or when the authentication device 10 is already carrying out the instruction code EX where is the same as instruction code EX which is received, the authentication device 10 periodically performs the processing c22-c27 between the processing regularly, and may confirm that the device to be authenticated 20 is not replaced with an imitation.

As described in FIG. 7, the authentication system according to the embodiment generates the MAC value M2 based on the instruction code EX in addition to the random number R1 and the secret ID cm. Therefore, only the device to be authenticated 20 of the regular product, which have both of the secret ID cm and the instruction code EX, generates the MAC value M1 which matches with the MAC value M2 of the authentication device 10 and succeeds in the authentication. Therefore, the device to be authenticated 30 of the imitation which does not have the secret ID cm fails in the authentication.

In addition, as explained by FIG. 3, it is not possible that the device to be authenticated 30 of the imitation pretends to be a regular product, even if the device to be authenticated 30 of the imitation utilized the device to be authenticated 20 of the regular product according to the authentication system in the embodiment. The prevention of the spoofing attack by the authentication system according to the embodiment will be explained successively.

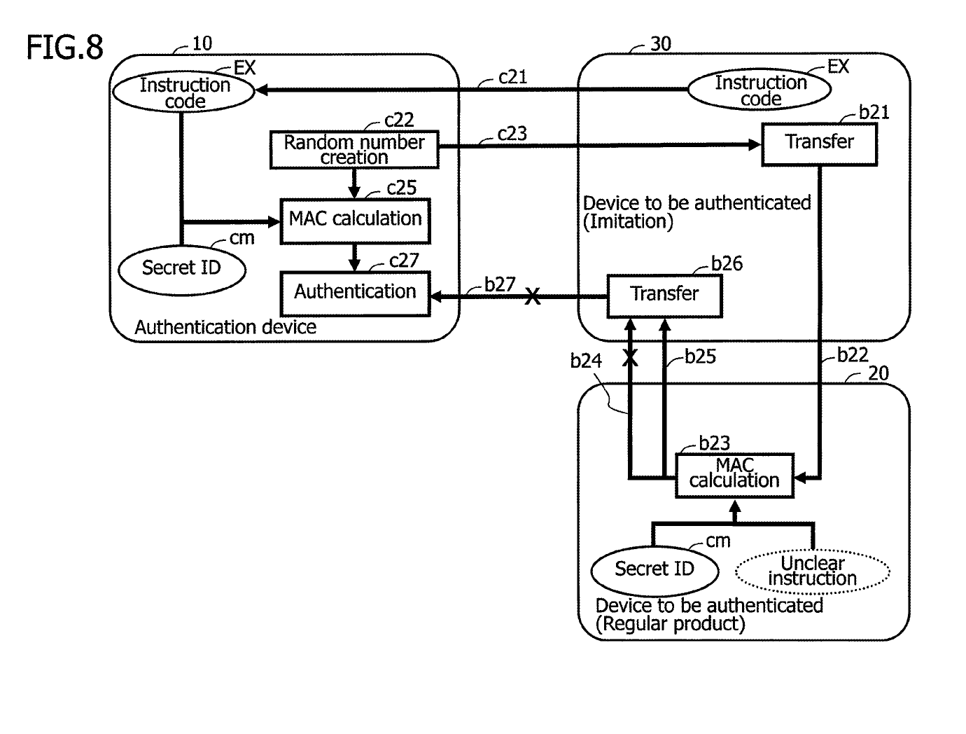

FIG. 8 is a diagram explaining the prevention of the spoofing attack by the authentication system according to the embodiment. As same as the example of the spoofing attack in FIG. 3, the device to be authenticated 30 of the imitation transfers the random number (the challenge value) R1, which is received from the authentication device 10, to the device to be authenticated 20 of the regular product (b21, b22). The device to be authenticated 20 of the regular product, when receiving the random number (the challenge value) R1, generates the MAC value M1 based on the received random number R1 (b23). But, the device to be authenticated 20 of the regular product, which receives the random number (the challenge value) R1, does not have the instruction code EX which the device to be authenticated 30 of the imitation transmitted. Therefore, it is not possible that the device to be authenticated 20 sends the MAC value M1 to the device to be authenticated 30 of the imitation, because it is not possible that the device to be authenticated 20 of the regular product generates the MAC value M1 (b24).

In addition, even if the device to be authenticated 20 of the regular product generates the MAC value M1 based on the random number R1 and the secret ID cm and either one of instruction code EX (b23), the instruction code EX, of which the device to be authenticated 20 of the regular product used to generate the MAC value M1, does not match with the instruction code EX of which the device to be authenticated 30 of the imitation published. Therefore, even if the device to be authenticated 30 of the imitation transfers the MAC value M1, which is acquired from the device to be authenticated 20 of the regular product, to the authentication device 10 (b25˜b27), the MAC value M1 which is transferred does not match with the MAC value M2 where the authentication device 10 generates (c27). Therefore, it is not possible that the device to be authenticated 30 of the imitation pretends to be a regular product even if the device to be authenticated 30 of the imitation uses the device to be authenticated 20 of the regular product.

As illustrated by FIG. 8, even if the device to be authenticated 30 of the imitation lets the device to be authenticated 20 of the regular product generate the MAC value M1, because the device to be authenticated 20 of the regular product does not have the instruction code EX of which the device to be authenticated 30 of the imitation sent to the authentication device 10, the device to be authenticated 20 of the regular product does not generate the MAC value M1 matching with the MAC value M2 of the authentication device 10. Therefore, because the device to be authenticated 30 of the imitation fails in the authentication, it is not possible that the device to be authenticated 30 of the imitation pretends to be a regular product.

As explained by FIG. 7 and FIG. 8, when the authentication device 10 connects to a plurality of the devices to be authenticated 20 of regular product and is operated based on the instruction code EX from the device to be authenticated 20, even if either one of the device to be authenticated 20 is replaced to an imitation from a regular product, it is possible to detect the device to be authenticated 30 of the imitation. And it is possible that the authentication device 10 evade control by the instruction code EX from the device to be authenticated 30 of the imitation which is determined. Therefore, it is restrained to use the device to be authenticated 30 of the imitation.

In addition, according to the authentication system in the embodiment, it is possible to evade a spoofing attack easily without newly encrypting and decrypting process to the processing in the existing challenge and response. Thereby, it is possible to hold down load to depend on the authentication process, and to reduce the cost. In addition, in the authentication system according to the embodiment, the authentication process is carried out in response to a issue of the instruction code EX. Thereby, it is possible to suppress the increase of communication data when the authentication device 10 is connected to large number of the device to be authenticated 20, because quantity of communication data is held down. In addition, it is possible to determine whether the device to be authenticated 20 is a regular product in an appropriate timing, because the authentication process is carried out in a timing of the issue of the instruction code EX.

Then, the detailed process in the MAC calculation units 107 and 205 will be explained. Firstly, a flow of the processing when realizing the MAC calculation units 107, 205 according to software will be explained. The process of the MAC calculation unit 107 in the authentication device 10 and the MAC calculation unit 205 in the device to be authenticated 20 is the same.

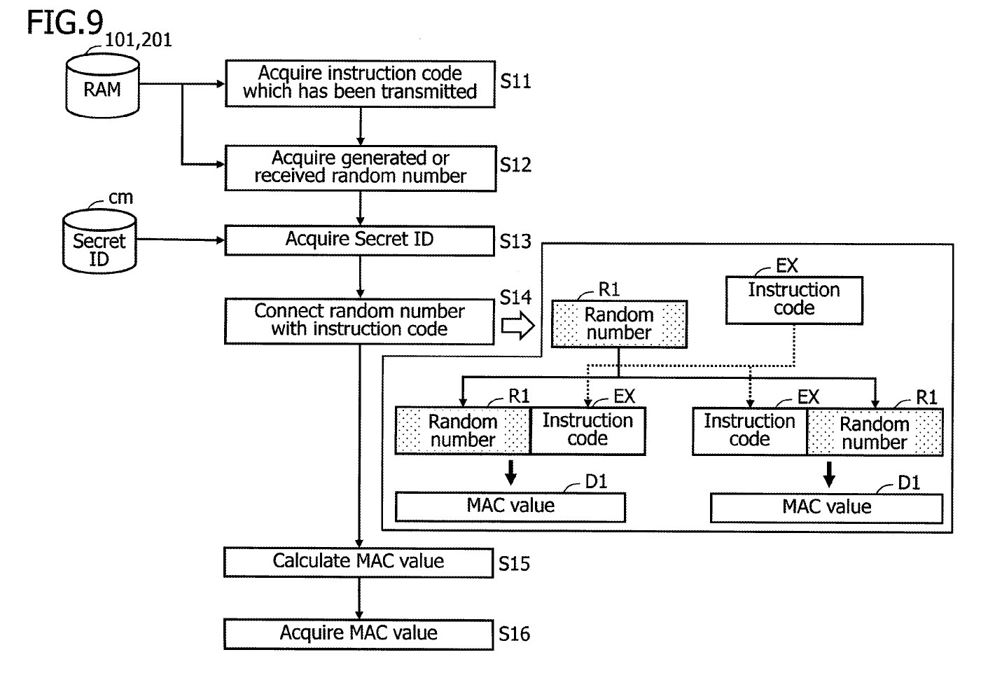

FIG. 9 is a flow diagram explaining a first embodiment of a flow of the processing when the MAC calculation unit 107, 205 illustrated in FIG. 5 and FIG. 6 are realized by software. In FIG. 9, same elements as illustrated in FIG. 5 and FIG. 6 are depicted by same reference signs. Firstly, the MAC calculation units 107 or 205 acquire the instruction code EX which is received (the authentication device 10 side) or the instruction code EX which has been transmitted (the device to be authenticated 20) from the RAM 105 or 204 (referring to FIG. 5 and FIG. 6) (S11). Then, the MAC calculation units 107 or 205 acquire the random number R1 which is generated (the authentication device 10 side) or the random number R1 which is received (the device to be authenticated 20) from the RAM 105 or 204 (referring to FIG. 5 and FIG. 6) (S12). In addition, the MAC calculation units 107, 205 acquire the secret ID cm to hold beforehand (S13).

Then, the MAC calculation units 107, 205 combines the random number R1 with the instruction code EX to create input data D1 of the calculation of the MAC values M1 and M2 (S14). For example, a case of the random number R1 “0xA829BDFC” and the instruction code EX “0xF0000001” is exemplified. In this case, the MAC calculation units 107, 205 connect the random number R1 and the instruction code EX to a permutation and generate the MAC calculation input data D1 “0xA829BDFCF0000001”. Or the MAC calculation unit 107, 205 connect the instruction code EX and the random number R1 to a permutation and may generate MAC calculation input data D1 “0xF0000001A829BDFC”. A combination method of the MAC calculation input data D1 may be which one method if the method is same between the MAC calculation unit 107 of the authentication device 10 and the MAC calculation unit 205 of the device to be authenticated 20.

When the MAC calculation input data D1 is generated by the combination, it is possible that the MAC calculation units 107, 205 generate the MAC calculation input data D1 only by memory operation. Therefore, it is possible that the MAC calculation units 107, 205 generate the MAC calculation input data D1 according to simple processing without performing a logical operation and an arithmetic operation.

Then, the MAC calculation units 107, 205 calculate the MAC values M1, M2 by inputs of the MAC calculation input data D1 and the secret ID cm (S15) and acquire it (S16). For example, the MAC calculation units 107, 205 calculate the MAC value M1, M2 based on methods such as HMAC (Hash-based message Authentication code) method or AES (Advanced Encryption Standard). Thereby, it is possible that the MAC calculation units 107, 205 generate the MAC values M1, M2 based on the random number R1 and the instruction code EX and the secret ID cm.

In addition, the MAC calculation input data D1 may be generated based on operation processing. As a second embodiment, a process flow that the MAC calculation units 107, 205 generate the MAC calculation input data D1 based on operation processing will be explained.

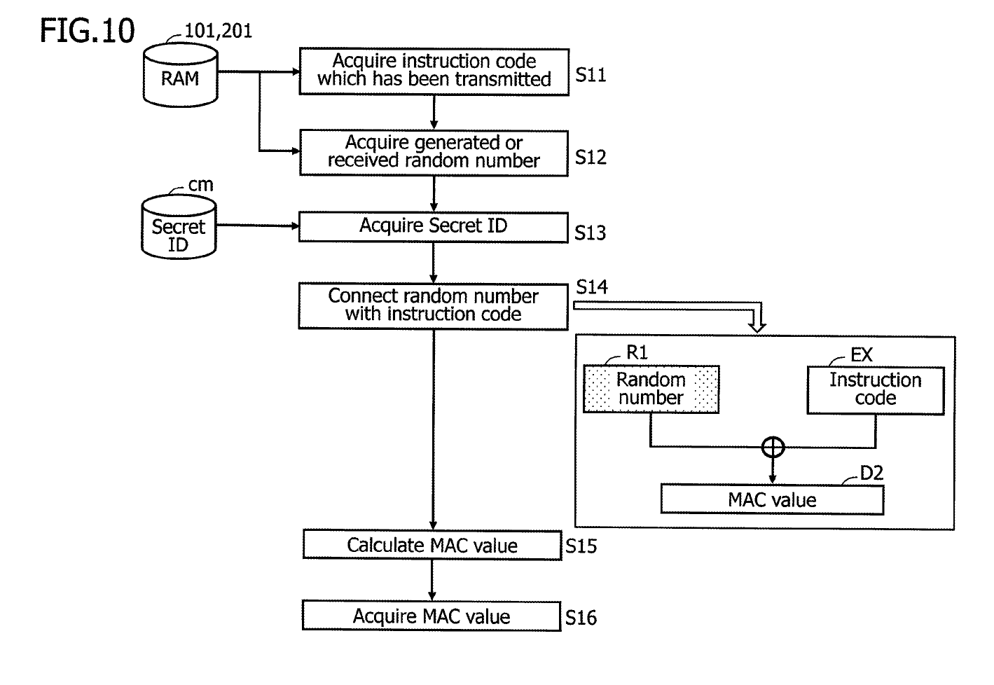

FIG. 10 is a flow diagram explaining a second embodiment of a flow of the processing when the MAC calculation unit 107, 205 illustrated in FIG. 5 and FIG. 6 are realized by software. In FIG. 10, same elements as illustrated in FIG. 9 are depicted by same reference signs. As similar to the first embodiment of FIG. 9, the MAC calculation units 107, 205 acquire the instruction code EX, the random number R1, the secret ID cm (S11˜S13). Then, the MAC calculation units 107, 205 combine the instruction code EX with the random number R1.

In the flow chart diagram of FIG. 10, the MAC calculation units 107 calculates the MAC calculation input data D2 of the calculation of the MAC values M1 and M2 by arithmetic operation of the random number R1 and the instruction code EX. The arithmetic operation may be which operation process of arithmetic operations such as an addition, or logical operations such as an XOR operation and an EOR operation. For example, a case of the random number R1 “0xA829BDFC” and the instruction code EX “0xF0000001” is exemplified. For example, the MAC calculation units 107, 205 execute an XOR operation of the random number R1 and the instruction code EX and generate the MAC calculation input data D2 “0x5829BDFD”. Or, for example, the MAC calculation units 107, 205 add the random number R1 to the instruction code EX and generate the MAC calculation input data D2 “0x19829BDFD”. The arithmetic processing, which generates the MAC calculation input data D2, may be which processing if the arithmetic operation is same between the MAC calculation unit 107 in the authentication device 10 and the MAC calculation unit 205 in the device to be authenticated 20.

Then, as similar to the flow chart diagram in FIG. 9, and the MAC calculation units 107, 205 calculates the MAC values M1, M2 as input in the MAC calculation input data D2 and the secret ID cm (S15), and acquires it (S16).

According to the method depicted by FIG. 10, the size of generated MAC calculation input data D2 becomes the big size among the sizes of the random number R1 and the instruction code EX. Therefore, it is possible that the MAC calculation units 107, 205 control smaller size of MAC calculation input data D2 than the first embodiment to combine the instruction code EX with the random number R1 and reduce memory capacity to use.

By using FIG. 9 and FIG. 10, the case that the MAC calculation units 107, 205 are realized by software is explained. However the MAC calculation region 107, 205 may be realized by hardware. Next, an embodiment that the MAC calculation units 107, 205 are realized according to the hardware will be explained. A construction of the MAC calculation unit 107 in the authentication device 10 is same as the MAC calculation unit 205 in the device to be authenticated 20.

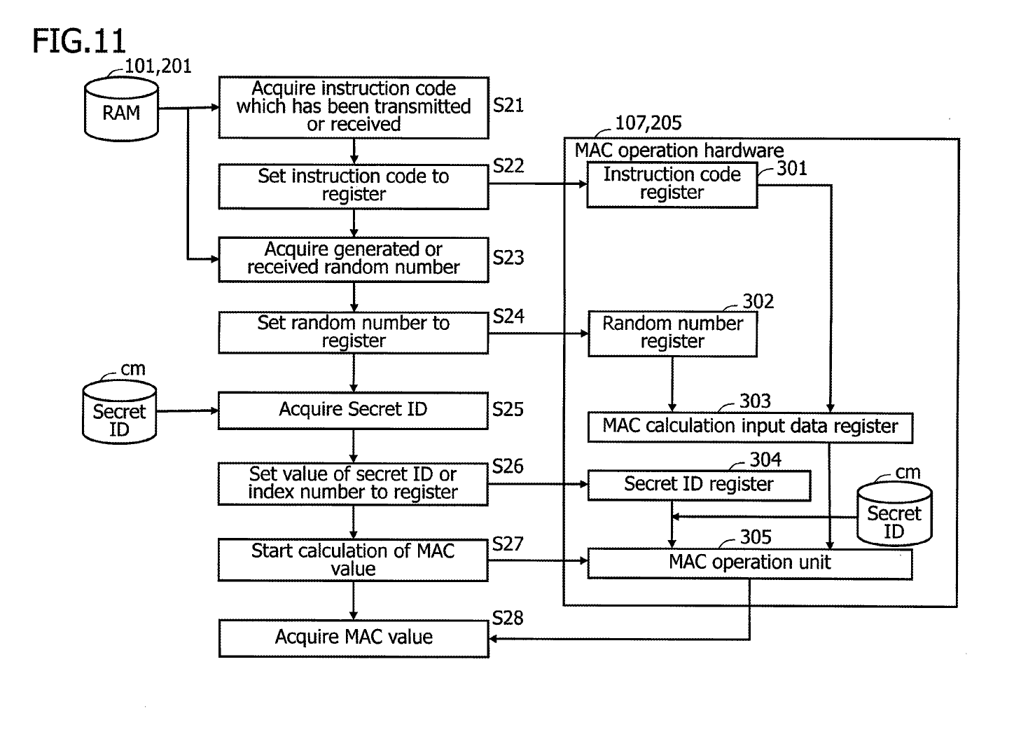

FIG. 11 is a diagram explaining a construction when the MAC calculation units 107, 205 are realized by hardware, according to a third embodiment. In FIG. 11, the construction of the MAC calculation units 107, 205 is depicted on right half and the process of the CPU 104, 202 (referring to FIG. 5 and FIG. 6) is depicted in left half. In addition, FIG. 11 illustrates the construction that the MAC calculation units 107, 205 connect the instruction code EX with the random number R1 and generate the MAC calculation input data D1 of the calculation of the MAC values M1 and M2.

As illustrated in FIG. 11, the MAC calculation unit 107, 205 have an instruction code register 301, a random number register 302, a MAC calculation input data register 303, a secret ID register 304, a MAC operation device 305. Each of registers stores values corresponding to register name. In addition, the MAC operation device 305 calculates the MAC value based on methods such as the HMAC or the AES.

Firstly, the CPU 104 or 202, when acquiring the instruction code EX which is received (the authentication device 10 side) or the instruction code EX which has been transmitted (the device to be authenticated 20) from the RAM 105 or 204 (S21), sets the acquired instruction code EX to the instruction code register 301 (S22). Then, the CPU 104 or 202 acquire the random number R1 which is generated (the authentication device 10 side) or the random number R1 which is received (the device to be authenticated 20) from the RAM 105 or 204 (S23) and sets the random number to the random number register 302 (S24). When the values are set to the random number register 302 and the instruction code register 301, a value which is connected the values is set to the MAC calculation input data register 303.

As same as, the CPU 104, 202 acquire the secret ID cm (S25), and sets the value of the secret ID cm or an index number to the secret ID register 304 (S26). For example, the CPU 104, 202 may sets the secret ID cm itself to the secret ID register 304. Or the index number of the secret ID register 304 is set, and the MAC operation device 305 acquires the secret ID cm from storing area of the secret ID cm based on the index number.

Then, the MAC operation device 305 starts the calculation (S27). The MAC operation device 305 calculates the MAC values M1, M2 by inputs of the value in the secret ID register 304 and value in the MAC calculation input data register 303 and outputs it. And the MAC calculation units 107, 205 acquires the MAC values M1, M2 which are output from the MAC operation device 305 (S28).

As described in FIG. 11, it is possible that the MAC calculation unit 107, 205 faster generate the MAC values M1, M2 by realizing the generation process of the MAC values M1 and M2 by hardware. In addition, a circuit scale is reduced because the authentication system in the embodiment does not have to add new encrypting and decrypting process to the process of challenge and response.

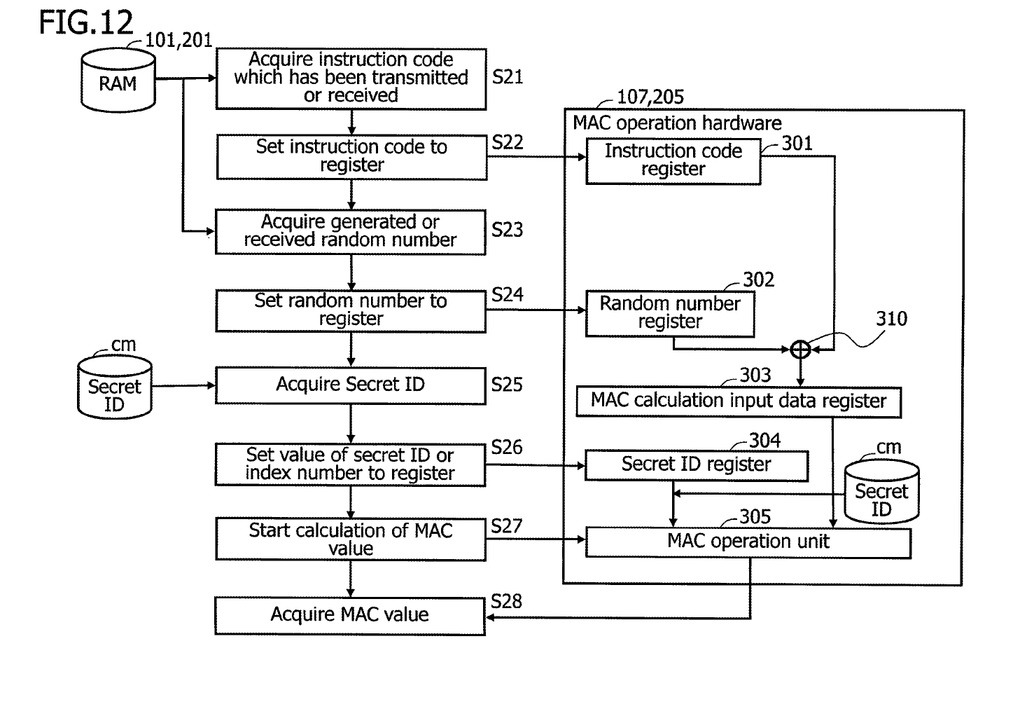

FIG. 12 is a diagram explaining a construction when the MAC calculation units 107, 205 are realized by hardware, according to a fourth embodiment. In FIG. 12, the construction of the MAC calculation units 107, 205 is depicted on right half and the process of the CPU 104, 202 (referring to FIG. 5 and FIG. 6) is depicted in left half. In addition, FIG. 12 illustrates the construction that the MAC calculation units 107, 205 performs the XOR operation of the instruction code EX with the random number R1 and generates the MAC calculation input data D2 of the calculation of the MAC values M1 and M2. However, it is not limited to an example in FIG. 12. For example, the MAC calculation unit 107, 205 may use the value of other logical operations such as the EOR operation of the random number R1 and the instruction code EX or the value of arithmetic operations such as the addition, as the MAC calculation input data D2.

In FIG. 12, same elements as elements illustrated in FIG. 11 are indicated by same reference signs. The MAC calculation units 107, 205 illustrated in FIG. 12, further have a XOR operation device 310 in addition to the construction of the MAC calculation units 107, 205 in FIG. 11. As illustrated in FIG. 12, the CPU 104, 202 set the instruction code EX, the random number R1 and the secret ID cm to the corresponding registers 301, 302, 304 as explained in FIG. 11 (S21˜S26). When a value is set to the random number register 302 and the instruction code register 301, the XOR operation device 310 performs the XOR operation of the inputs which have values in the random number register 302 and the instruction code register 301, and sets the value of the result to the MAC calculation input data register 303.

Then, the MAC calculation units 107, 205 start the calculation by using the MAC operation device 305 (S27). The MAC operation device 305 is input the value of the secret ID register 304 and the value in the MAC calculation input data register 303 and calculates the MAC values M1 and M2 and outputs it. And the MAC calculation units 107, 205 acquire the MAC value M1, M2 output by the MAC operation device 305 (S28).

It is possible to become the size of MAC calculation data register 303 smaller because the MAC calculation unit 107, 205 sets the value of the XOR operation of the random number R1 and the instruction code EX to the MAC calculation data register 303. In an example of FIG. 12, the size of the MAC calculation data register 303 becomes the bigger size among the size of the random number R1 and the instruction code EX. It is possible to reduce a circuit scale because the size of the register is held down small.

Next, a specific example of the authentication processing according to the embodiment will be explained. In the example, the authentication device 10 exemplifies an air-conditioner, and the device to be authenticated 20 exemplifies a remote controller. The remote controller transmits the instruction code EX which controls the air-conditioner to the air-conditioner. As represented by the example, in the embodiment, the authentication device 10 and the device to be authenticated 20 may be a different product or may be the different parts included in the same product.

### Specific Example

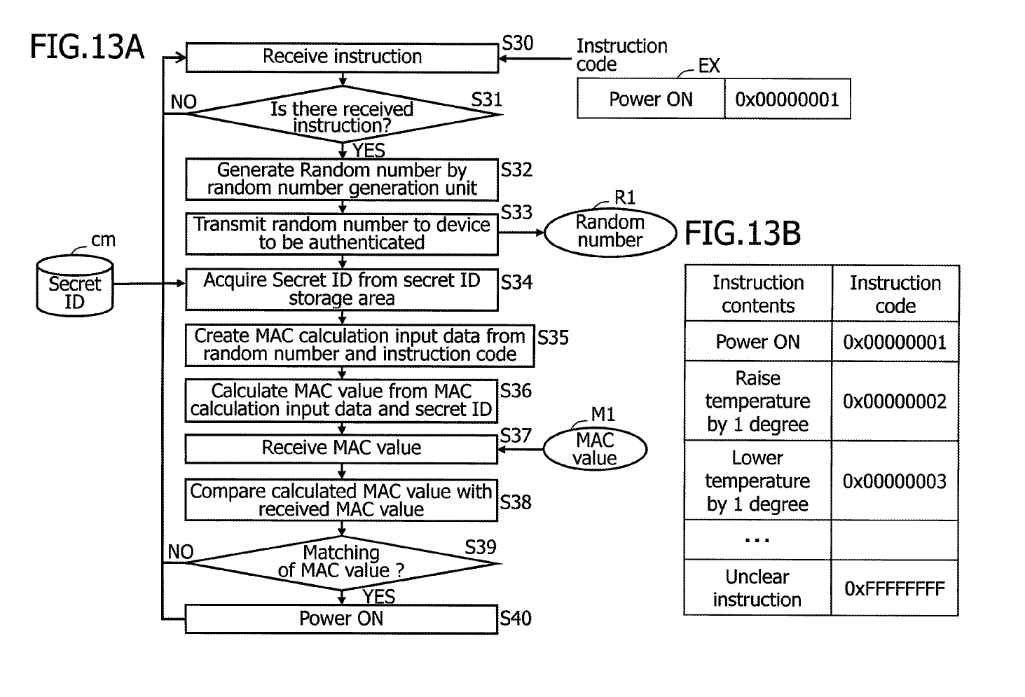

FIG. 13A and FIG. 13B are diagrams explaining a specific example of the process of the authentication device 10 in the authentication system according to the embodiment. In FIG. 13A, same elements as depicted by FIG. 9 are represented by same reference signs. In FIG. 13A, the process of steps S34-S36 corresponds to the process in the flow chart in FIG. 9, FIG. 10, FIG. 11, and FIG. 12.

As represented by FIG. 13B, the control contents of the air-conditioner with the remote controller, includes, for example, “power supply ON”, “higher temperature by 1 degree Celsius”, and “lower temperature by 1 degree Celsius”. As illustrated in FIG. 13A, for example, the remote controller publishes the instruction code EX “0x00000001” when entering the power supply of the air-conditioner. In addition, the remote controller publishes the instruction code EX “0x00000002” when raising the temperature of the air-conditioner by 1 degree. In addition, the remote controller has instruction code EX “0xFFFFFFFF” indicating an unknown order.

The air-conditioner which is the authentication device 10 receives the instruction code EX “0x00000001” indicating power supply ON from the remote controller which is the device to be authenticated 20, for example (S30). When receiving the instruction code EX “0x00000001” (YES/S31), the random number generation unit 102 in the authentication device 10 generates the random number R1 (S32). Then, the authentication device 10 transmits the random number R1 to the device to be authenticated 20 of the origin of transmission of the instruction code EX “0x00000001” (S33). In addition, the authentication device 10 acquires the secret ID cm from the secret ID storage area (S34), and generates the MAC calculation input data based on the random number R1 and the instruction code EX (S35). Next, the authentication device 10 calculates the MAC value M2 based on the MAC calculation input data and the secret ID cm (S36).

And the authentication device 10 receives the MAC value M1 of which the remote controller generates from the remote controller which is the device to be authenticated 20 and compares the MAC value M1 with the MAC value M2 which is generated in an own device (S38). The air-conditioner which is the authentication device 10, when the MAC value M1 matches with the MAC value M2 by a result of comparison (YES/S39), carries out control of power supply ON (S40). On the other hand, the air-conditioner which is the authentication device 10, when the MAC value M1 does not match with the MAC value M2 by a result of comparison (NO/S39), returns to the reception processing (S30) of the instruction code EX without controlling the power supply ON.

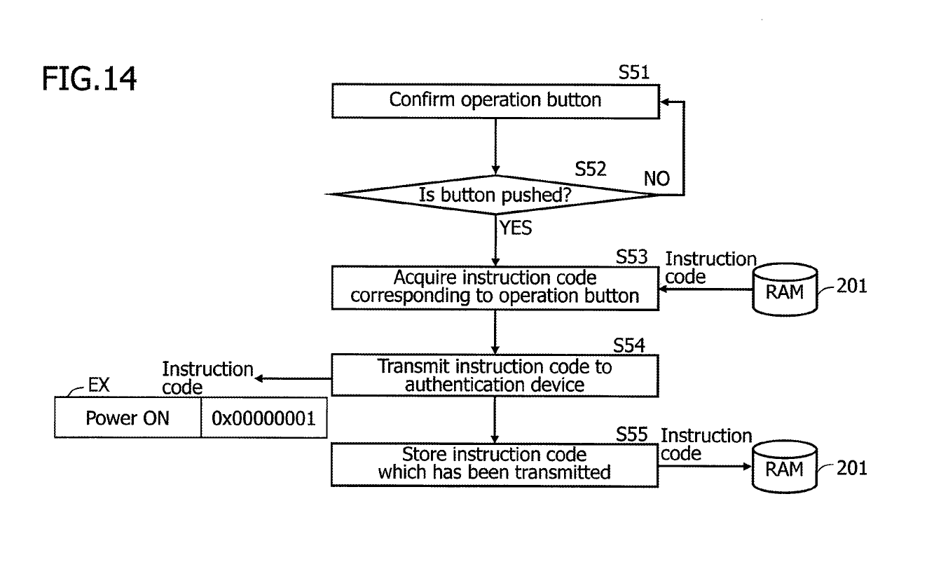

FIG. 14 is a diagram explaining a specific example of the instruction code transmission process of the device to be authenticated 20 in the authentication system in FIG. 13. As mentioned above by FIG. 13, the remote controller which is the device to be authenticated 20 transmits the instruction code EX, for example, “raising temperature 1 degree Celsius”, “power supply ON” and “lowering temperature 1 degree Celsius” to the authentication device 10.

The remote controller which is the device to be authenticated 20 confirms whether or not an operation button is pushed (S51). The device to be authenticated 20 acquires the instruction code EX “0x00000001” corresponding to the operation button (in this example, an operation button corresponding to the power supply ON) from the instruction storage area (S53), when the operation button is pushed down (YES/S52). And the device to be authenticated 20 transmits the instruction code EX to the authentication device 10 (S54). In addition, the device to be authenticated 20 stores the instruction code EX “0x00000001” which is transmitted to the memory (RAM) 204 (S55).

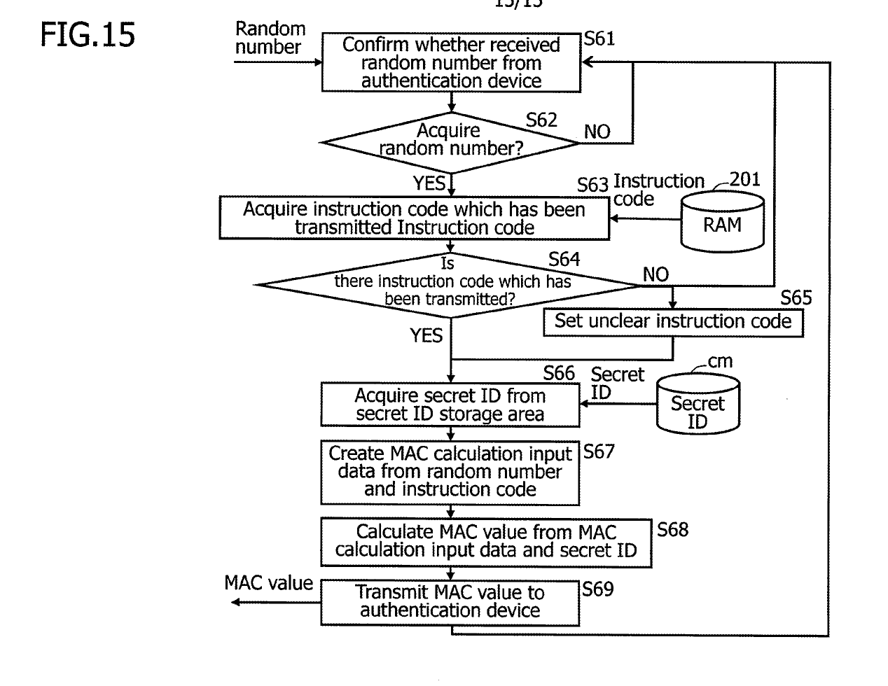

FIG. 15 is a diagram explaining a specific example of the MAC value calculation and transmission process of the device to be authenticated 20 in the authentication system in FIG. 13A and FIG. 13B. In FIG. 15, same elements as depicted by FIG. 13A are represented by same reference signs. In FIG. 15, the process of steps S66-S68 corresponds to the process in the flow chart in FIG. 9, FIG. 10, FIG. 11, and FIG. 12.

As mentioned in FIG. 14, the remote controller which is the device to be authenticated 20, when outputting the instruction code EX “0x00000001” to the air-conditioner which is authentication device 10, confirms whether or not the random number R1 is received from the authentication device 10 (S61). The device to be authenticated 20, when receiving the random number R1 (YES/S62), acquires the instruction code EX “0x00000001”, which has been transmitted to the authentication device 10, from the memory (RAM) 204 (S63). The device to be authenticated 20 acquires the secret ID cm from the secret ID cm storage area (S66) when there is the instruction code EX where the device to be authenticated 20 has been transmitted in the memory (RAM) 204 (YES/S64).

Then, the device to be authenticated 20 generates the MAC calculation input data based on the random number R1 and the instruction code EX “0x00000001” (S67). In addition, the device to be authenticated 20 calculates the MAC value M1 based on the MAC calculation input data and the secret ID cm (S68), and transmits it to the authentication device 10 (S69). And the device to be authenticated 20 returns to the reception confirmation process (S61) of the random number R1.

On the other hand, when there is not the instruction code EX which has been transmitted in the memory (RAM) 204 (NO/S64), the device to be authenticated 20 sets unclear instruction code EX “0xFFFFFFFF” in the instruction code EX (S65). A case when there is not the instruction code EX which has been transmitted (NO/S64), is a case that the device to be authenticated 20 except the device to be authenticated 20, which transmitted the instruction code EX, receives the random number R1. In other words, a case when there is not the instruction code EX which has been transmitted (NO/S64), corresponds a case when the device to be authenticated 20 of the regular product receives the random number R1 from the device to be authenticated 30 of the imitation.

When the unclear instruction code EX “0xFFFFFFFF” is set in the instruction code EX (S65), the device to be authenticated 20 calculates the MAC value M1 based on the secret ID cm and the random number R1 and the instruction code EX “0xFFFFFFFF”, as same as when acquiring the instruction code EX which has been transmitted (S66˜S68). And the device to be authenticated 20 transmits the calculated MAC value M1 to the authentication device 10. The calculated MAC value M1 does not match with the MAC value M2 of which the authentication device 10 generates, because the MAC value M1 is based on the unclear instruction code EX “0xFFFFFFFF”. Therefore, the device to be authenticated 30 of the imitation fails in the authentication.

In addition, when there is not the instruction code EX which has been transmitted in the memory (RAM) 204 (NO/S64), the device to be authenticated 20 may return to the reception awaiting process of the random number R1 (S61). When the process returns to the process of awaiting reception random number R1, the device to be authenticated 20 does not generate the MAC value M1. Therefore, because the authentication device 10 does not receive the MAC value M1 from the device to be authenticated 20, the device to be authenticated 30 of the imitation fails in the authentication.

The authentication system in the embodiment has the authentication device 10 and the device to be authenticated 20 which communicates with the authentication device 10 as above described. And the device to be authenticated 20 has an instruction code transmission unit 203 which generates the instruction code EX controlling the authentication device 10 and transmits to the authentication device 10, and a first comparison value generation unit 205 which generates a first comparison value (the MAC value) M1 based on the random number R1, which is received from the authentication device 10, the secret identification information (the secret ID)cm, of which the authentication device 10 and the device to be authenticated 20 commonly have, and the instruction code EX. In addition, the authentication device 10 has a random number generation unit 102 to generate the random number R1, a second comparison value generation unit 107 to generate the second comparison value (MAC value) M2 based on the random number R1 and the secret identification information (secret ID) cm and the instruction code EX, and a control unit to carry out the instruction code EX.

And, in the authentication system, the instruction code transmission unit 203 in the device to be authenticated 20 transmits the instruction code EX to the authentication device 10 and the random number generation unit 102 in the authentication device 10 generates the random number R1 in response to the reception of the instruction code EX and transmits it to the device to be authenticated 20. And the first comparison value generation unit 205 in the device to be authenticated 20 generates a first comparison value M1 in response to the reception of random number R1 and sends it to the authentication device 10, and the second comparison value generation unit 107 in the authentication device 10 generates a second comparison value M2 in response to the reception of instruction code EX. And the control unit in the authentication device 10 carries out the instruction code EX when the second comparison value M2 matches with the first comparison value M1 which is received from the device to be authenticated 20.

The authentication system in the embodiment generates the MAC value M1 based on the instruction code EX in addition to the secret ID cm. In other words, only device to be authenticated 20, which have both of the secret ID cm and the instruction code EX, succeeds in the authentication and is able to control the authentication device 10 based on the instruction code EX concerned. Therefore, the device to be authenticated 30 of the imitation, which does not have the secret ID cm, fails in the authentication, because the device to be authenticated 30 of the imitation is unable to generate the MAC value M1 matching with the MAC value M2 of which the authentication device 10 generates. Thereby, it is possible that the authentication system evades the control of the authentication device 10 with the device to be authenticated 30 of the imitation.

In addition, it is possible that the authentication system prevents the spoofing attack to the regular product of which the device to be authenticated 30 of the imitation used the device to be authenticated 20 of the regular product. Only the device to be authenticated 20 of the main constituent, which controls the authentication device 10, is able to publish the instruction code EX. In other words, it is not possible that the first device to be authenticated 20 detects the instruction code EX of which different second device to be authenticated 20 transmitted to the authentication device 10. Therefore, it is not possible to generate the MAC value M1 matching with the MAC value M2 of the authentication device 10, even if the device to be authenticated 30 of the limitation make the device to be authenticated 20 of the regular product to generate the MAC value M1, because the device to be authenticated 20 of the regular product does not have the instruction code EX of which the device to be authenticated 30 of the imitation sent to the authentication device 10. Therefore, the device to be authenticated 30 of the imitation fails in the authentication, and it is not possible that the device to be authenticated 30 of the imitation pretends to be a regular product.

In this way, in the authentication system in the embodiment, when the authentication device 10 connects to the device to be authenticated 20 of plural regular products and the authentication device 10 is operated by the device to be authenticated 20 based on the instruction code EX, it is possible to detect the device to be authenticated 30 of the imitation, even if either device to be authenticated 20 is replaced to an imitation from the regular product. And it is possible that the authentication device 10 evade to control by the instruction code EX from the device to be authenticated 30 which is determined the imitation. Therefore, it is possible to restrain the use of device to be authenticated 30 of the imitation.

In addition, according to the authentication system in the embodiment, it is possible to detect the device to be authenticated 30 of the imitation only based on the judgment process of the MAC value. In other words, it is possible that the authentication system in the embodiment prevents a spoofing attack easily without adding new encrypting and decrypting processing to the processing of the challenge and response. Therefore, it is possible that the implementation of the authentication processing in the embodiment becomes easily, and that the cost is held down, too. In addition, it is possible that the authentication system suppresses increase of the load to depend on the authentication processing.

In addition, in the authentication system in the embodiment, the authentication process is carried out in a timing of the transmission of the instruction code EX. Therefore, it is evaded that communication data increase when the authentication device 10 is connected to a plurality of the devices to be authenticated 20, because the authentication processing is not performed while the transmission of instruction code EX is not carried out.

In addition, in the authentication system in the embodiment, the first comparison value generation unit of the device to be authenticated generates the first comparison value based on the input value (MAC calculation input data) that is connected the random number and the instruction code and the secret identification information. And the second comparison value generation unit of the authentication device generates the second comparison value based on the input value (MAC calculation input data) that is connected the random number and the instruction code and the secret identification information. Thereby, it is possible that the authentication system generates an input value according to simple processing only for memory operation.

Or, the first comparison value generation unit of the device to be authenticated generates the first comparison value based on an input value (MAC calculation input data), which is generated by a logical operation or an arithmetic operation of the random number and the instruction code, and the secret identification information. And the second comparison value generation unit of the authentication device generates a second comparison value based on input value (MAC calculation input data) which is generated by the logical operation or the arithmetic operation of the random number and the instruction code, and the secret identification information. Thereby, it is possible that the authentication system holds the size of the input value in check and hold down the memory capacity to use. In addition, it is possible that a circuit scale is held down small when the MAC value generation processing is realized by hardware.

In addition, in the authentication system in the embodiment, the first comparison value generation unit of the device to be authenticated and the second comparison value generation unit of the authentication device respectively generate the first and a second comparison value based on either of HMAC method or the AES method. Even when the authentication system uses either the generation method of MAC value, it is possible to detect the device to be authenticated 30 of the imitation.

In addition, in the authentication system in the embodiment, the first comparison value generation unit of the device to be authenticated and the second comparison value generation unit of the authentication device respectively generate the first and the second comparison value based on a plurality of secret identification information (secret ID). Therefore, it is possible that the authentication system makes the generation of the MAC value by the third party more difficult by using the plurality of secret IDs.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. Authentication system comprising:
a device to be authenticated including:
a first communication unit configured to transmit an instruction code for control of an authentication device and a first comparison value to the authentication device, and to receive a random number from the authentication device;
a first memory unit which stores common secret identification information; and
a first control unit configured to create the first comparison value based on the random number, the common secret identification information and the instruction code in response to a reception of the random number, and
the authentication device including:
a second communication unit configured to transmit the random number to the device to be authenticated and to receive the instruction code and the first comparison value from the device to be authenticated;
a second memory unit which stores the common secret identification information; and
a second control unit configured to generate the random number in response to a reception of the instruction code, create a second comparison value based on the random number, the common secret identification information and the instruction code, compare the first comparison value which is received from the device to be authenticated with the second comparison value, and execute the instruction code when the first comparison value matches with the second comparison value.

2. The authentication system according to claim 1, wherein the first control unit is configured to create the first comparison value based on a first input value and the common secret identification information, the first input value being generated by the random number being connected with the instruction code and
the second control unit is configured to create the second comparison value based on a second input value and the common secret identification information, the second input value being generated by the random number being connected with the instruction code.

3. The authentication system according to claim 1, wherein the first control unit is configured to create the first comparison value based on a first input value and the common secret identification information, the first input value being generated by one of a logical operation and an arithmetic operation being operated with respect to the random number and the instruction code, and
the second control unit is configured to create the second comparison value based on a second input value and the common secret identification information, the second input value being generated by one of the logical operation and the arithmetic operation being operated with respect to the random number and the instruction code.

4. The authentication system according to claim 1, wherein each of the first and second control units is configured to create the first comparison value and the second comparison value based on either one of HMAC (Hash-based message Authentication code) method or AES (Advanced Encryption Standard) method.

5. The authentication system according to claim 1, wherein each of the first and second control units is configured to create the first comparison value and the second comparison value based on a plurality of the common secret identification information.

6. An method for authentication comprising:
transmitting an instruction code for controlling the authentication device to the authentication device from a device to be authenticated;
generating, by the authentication device, a random number in response to a reception of the instruction code;
transmitting the random number to the device to be authenticated from the authentication device;
creating, by the device to be authenticated, a first comparison value based on the random number, a common secret identification information and the instruction code in response to a reception of the random number;
transmitting the first comparison value to the authentication device from the device to be authenticated;
creating, by the authentication device, a second comparison value based on the random number, the common secret identification information and the instruction code;
comparing, by the authentication device, the first comparison value with the second comparison value; and
executing, by the authentication device, the instruction code when the first comparison value matches with the second comparison value.

7. The method for authentication according to claim 6, wherein the creating the first comparison value comprises creating the first comparison value based on a first input value and the common secret identification information, the first input value being generated by the random number being connected with the instruction code, and
the creating the second comparison value comprises creating the second comparison value based on a second input value and the common secret identification information, the second input value being generated by the random number being connected with the instruction code.

8. The method for authentication according to claim 6, wherein the creating the first comparison value comprises creating the first comparison value based on a first input value and the common secret identification information, the first input value being generated by one of a logical operation and an arithmetic operation being operated with respect to the random number and the instruction code, and
the creating the second comparison value comprises creating the second comparison value based on a second input value and the common secret identification information, the second input value being generated by one of the logical operation and the arithmetic operation being operated with respect to the random number and the instruction code.

9. The method for authentication according to claim 6, wherein the creating the first comparison value comprises creating the first comparison value based on either one of HMAC (Hash-based message Authentication code) method or AES (Advanced Encryption Standard) method, and
the creating the second comparison value comprises creating the second comparison value based on either one of HMAC method or AES method.

10. The method for authentication according to claim 6, wherein the creating the first comparison value comprises creating the first comparison value based on a plurality of the common secret identification information, and
the creating the second comparison value comprises creating the second comparison value based on the plurality of the common secret identification information.

11. An authentication device comprising:
a communication unit configured to transmit a random number to a device to be authenticated and to receive an instruction code and a first comparison value from the device to be authenticated;
a memory unit which stores a common secret identification information; and
a control unit configured to generate the random number in response to a reception of the instruction code, create a second comparison value based on the random number, the common secret identification information and the instruction code, compare the first comparison value, which is created based on the random number, the common secret identification information and the instruction code by the device to be authenticated, with the second comparison value, and execute the instruction code when the first comparison value matches with the second comparison value.

12. The authentication device according to claim 11, wherein the control unit is configured to create the second comparison value based on an input value, which is generated by the random number being connected with the instruction code, and the common secret identification information.

13. The authentication device according to claim 11, wherein the control unit is configured to create the second comparison value based on an input value, which is generated by one of a logical operation and an arithmetic operation being operated with respect to the random number with the instruction code, and the common secret identification information.

14. The authentication device according to claim 11, wherein the control unit is configured to create the second comparison value based on either one of HMAC (Hash-based message Authentication code) method or AES (Advanced Encryption Standard) method.

15. The authentication device according to claim 11, wherein the control unit is configured to create the second comparison value based on a plurality of the secret identification information.

16. A device to be authenticated comprising:
a communication unit configured to transmit an instruction code for control of an authentication device and a first comparison value to the authentication device, and to receive a random number from the authentication device;
a memory unit which stores common secret identification information; and
a control unit configured to create the first comparison value based on the random number, the common secret identification information and the instruction code in response to a reception of the random number, the first comparison value being compared with a second comparison value which is created based on the random number, the common secret information and the instruction code by the authentication device, the instruction code being executed when the first comparison value matches with the second comparison value.

17. The device to be authenticated according to claim 16, wherein the control unit is configured to create the first comparison value based on an input value, which is generated by the random number being connected with the instruction code, and the common secret identification information.

18. The device to be authenticated according to claim 16, wherein the control unit is configured to create the first comparison value based on an input value, which is generated by one of a logical operation and an arithmetic operation being operated with respect to the random number and the instruction code, and the common secret identification information.

19. The device to be authenticated according to claim 16, wherein the control unit is configured to create the first comparison value based on either one of HMAC (Hash-based message Authentication code) method or AES (Advanced Encryption Standard) method.

20. The device to be authenticated according to claim 16, wherein the control unit is configured to create the first comparison value based on a plurality of the secret identification information.
